(19) United States
(12) Patent Application Publication
(10) Pub. No.: US 2009/0055766 A1
(43) Pub. Date: Feb. 26, 2009

(54) Content Scheduling Method and Scheduling Interface of Display

(76) Inventors: JENN-SHOOU YOUNG, Hsin-Chu City (TW); Sheng-Yuan Huang, Hsin-Chu City (TW)

Correspondence Address: HDLS Patent & Trademark Services, P.O. BOX 220746, CHANTILLY, VA, 20153-0746, US

(21) Appl. No.: 11/959,149

(22) Filed: Dec. 18, 2007

(30) Foreign Application Priority Data
Aug. 24, 2007 (TW) 096131360

(51) Int. Cl. G06F 3/048

(52) U.S. Cl. 715/771

(57) ABSTRACT

The invention discloses a content scheduling method and a scheduling interface of display, and a display with image retention removal. The content scheduling method creates a timer item with a program timer at least in a main menu of an on screen display (OSD), selects the program timer to pop up a program timer interface and inputs at least one content scheduling record. Moreover, the mentioned method includes the steps of popping up a repeat timer interface and then inputting a repeat content scheduling record or a multiple displays content scheduling record to the repeat timer interface if the scheduling record existing a repeat timer index.

### BACKGROUND

The present invention relates to a content scheduling and image retention removal technique, and more specifically, to a method, an interface and a display for content scheduling and image retention removal through an on screen display (OSD).

With referring to FIG. 1, a conventional digital signage display system 1 includes a computer terminal 11, five digital signage boxes/media boxes/server boxes 12 to 16 and a video wall display unit 17 consisting of four displays 171 to 174. In the embodiment, the digital signage box 12 acts as a master device of the others, and it controls the content, the sequence and the position to be displayed in the digital signage boxes 13 to 16 according to a display list edited in a management software of the computer terminal 11. For instance, the digital signage boxes 13 to 16 may either display a same advertisement segment in the displays 171 to 174 simultaneously, display each quarter of the same advertisement segment mentioned in the displays 171 to 174 respectively, or display the mentioned advertisement segment in turn to show the flowing effect. However, the mentioned embodiment has the disadvantages of increasing the costs in establishing and maintaining of hardware and software, training and hiring system administrator and remedying lost business opportunity resulted from updating the advertisement indirectly. Moreover, the dual and horizontally allocated windows lacks of flexibility in the applications since it's restricted to display the different content in each window at the same time.

As shown in FIG. 2, an OSD 20 of a display 2 has a brightness adjustment item 211, a contrast adjustment item 212, a screen adjustment item 213, an OSD setting item 214 and miscellaneous adjustment item 215. The corresponding advanced item and an input zone of parameter value pops up when a user selects the mentioned items. For instance, an OSD horizontal position adjustment item 221, an OSD vertical position adjustment item 222 and an OSD language setting item 223 are displayed for setting when the user selects the OSD setting item 214. Unfortunately, it still lacks of a direct way for satisfying the user's demands such as direct content scheduling, equipment integration, easy migration and in fashion.

Accordingly, no matter what the ordinary digital signage display system equips single or multiple displays, it really increases the costs in many aspects and lacks of flexibility, and the problem of the display quality diminution resulted from the image retention is another issue to be solved.

### BRIEF SUMMARY

A method, an interface and a display for content scheduling and image retention removal through operating an OSD directly is provided.

According to one preferred embodiment of the present invention, a content scheduling method for performing a content scheduling of a display with one to many content scheduling records includes the steps of creating a timer item with a program timer in an on screen display (OSD) of the display, selecting the program timer to pop up a program timer interface, and inputting the content scheduling records in the program timer interface.

Yet according to another preferred embodiment of the present invention, a scheduling interface of display for performing a content scheduling of a display with one to many content scheduling records is disclosed. The scheduling interface includes a program timer interface for inputting the content scheduling record, a timer menu with a program timer item for popping up the program timer interface, and an OSD menu with a timer item for popping up the timer menu.

Yet according to one preferred embodiment of the present invention, a display with image retention removal has a program timer interface for inputting the content scheduling records, and an inputted content of a function field of the content scheduling record indicates the removal of image retention. Thus the image retention resulted from frequent displaying is eliminated and avoided.

The present invention reduces the costs of an expense in system environment establishing and maintaining, training fee and salary of system administrator, and also eliminates the disadvantages of indirect update and late response resulted from the prior art. In addition, the way for achieving image retention removal is assigned to a function field of the content scheduling record.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of a digital signage display system according to the prior art.

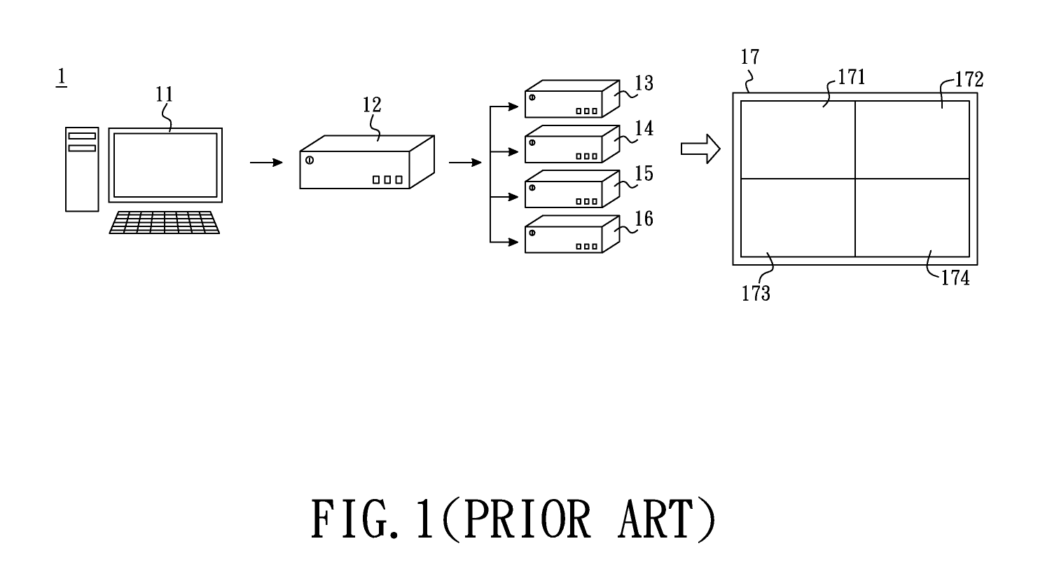

FIG. 2 is a diagram of an OSD of a display according to the prior art.

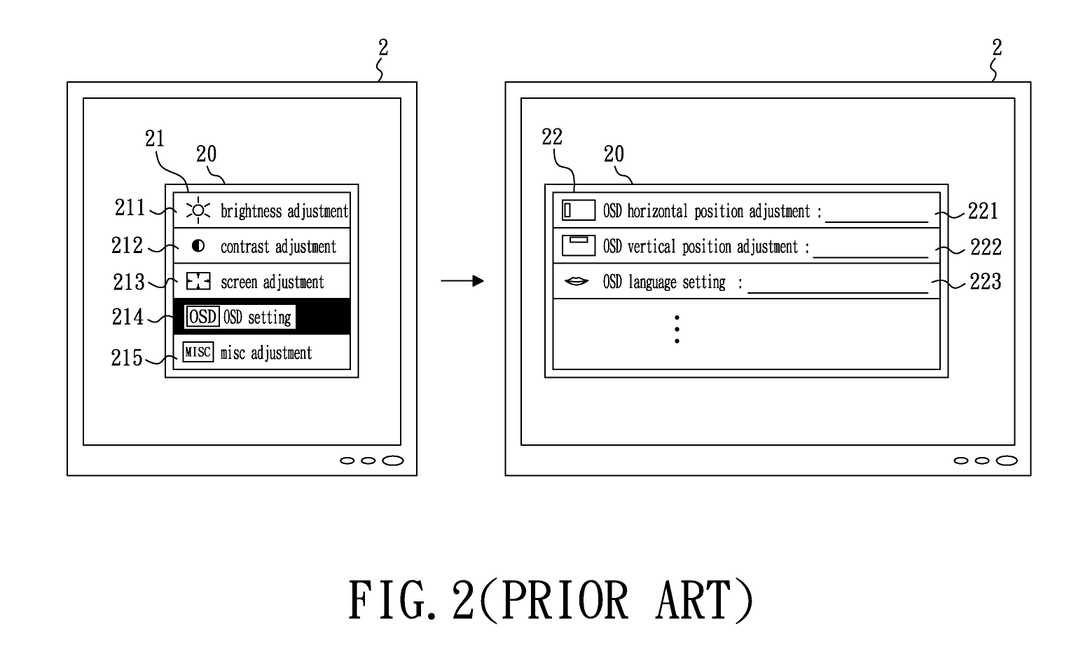

FIG. 3 is a flow chart of a content scheduling method according to the present invention.

FIG. 4A is a diagram of a scheduling interface of a display according to the present invention.

FIG. 4B is a diagram of a repeat timer interface in response to a repeat timer index according to the present invention.

FIG. 5 is a diagram of a display with image retention removal according to the present invention.

### DETAILED DESCRIPTION

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

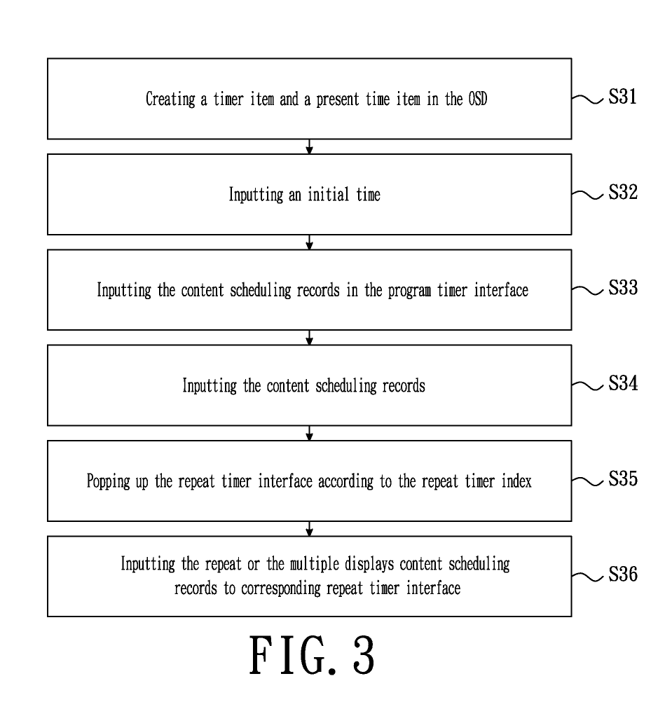

With referring to FIG. 3, according to an embodiment of the present invention, a content scheduling method for performing a content scheduling of a display with one to many content scheduling records creates a timer item and a present time item in an on screen display (OSD) of the display in step S31. Herein, the timer item has a program timer, a repeat timer and the present time item, and each of them pops up corresponding interface for advanced inputting. Then, the present content scheduling method inputs an initial time in the present time item in step S32, selects the program timer to pop up a program timer interface in step S33, and inputs one to many content scheduling records in the program timer interface in step S34. The content scheduling record includes a display date field, a start time field, a finish time field, an input field and a function field, and an inputted content of the function field indicates one of an image retention removal and an execution of a repeat timer index. For instance, the inputted content of each content scheduling record may be an ORB (orbiter), an INV (inverse) or a WT (white) for indicating an expected special effect for image retention removal. On the other hand, the inputted content may be a repeat timer index for indicating the execution of the repeat timer index, and herein REP N represents to a maximal number of the repeat content scheduling records allowed to input. There are same amount of the repeat timer interface being popped up for each of the repeat content scheduling records to fill in.

Again, the present method pops up the repeat timer interface if the inputted content is the repeat timer index in step S35, and inputs one to many of the repeat content scheduling records or the multiple displays content scheduling records to corresponding repeat timer interface in step S36. Herein, a video wall monitor item and a multiple screens item of the multiple displays item are provided for fulfilling the requirement of multi-display content scheduling, and the multiple displays content scheduling records are inputted after a selection of the video wall monitor item and the multiple screens item. It's noted that the repeat content scheduling record includes a repeat state field, a divide mode field, a repeat duration field and a source allocation field, and that of the multiple displays content scheduling record is a display amount field, a display duration field and an input source field. The source allocation field may be a single video source, and the source allocation field further includes a first window source field and a second window source field for the dual window schema as well. For instance, the first window is the main or the left one of two windows, whereas the second window is the sub or the right one of them. Thus the respective source is assigned to corresponding ones of mentioned two window source fields.

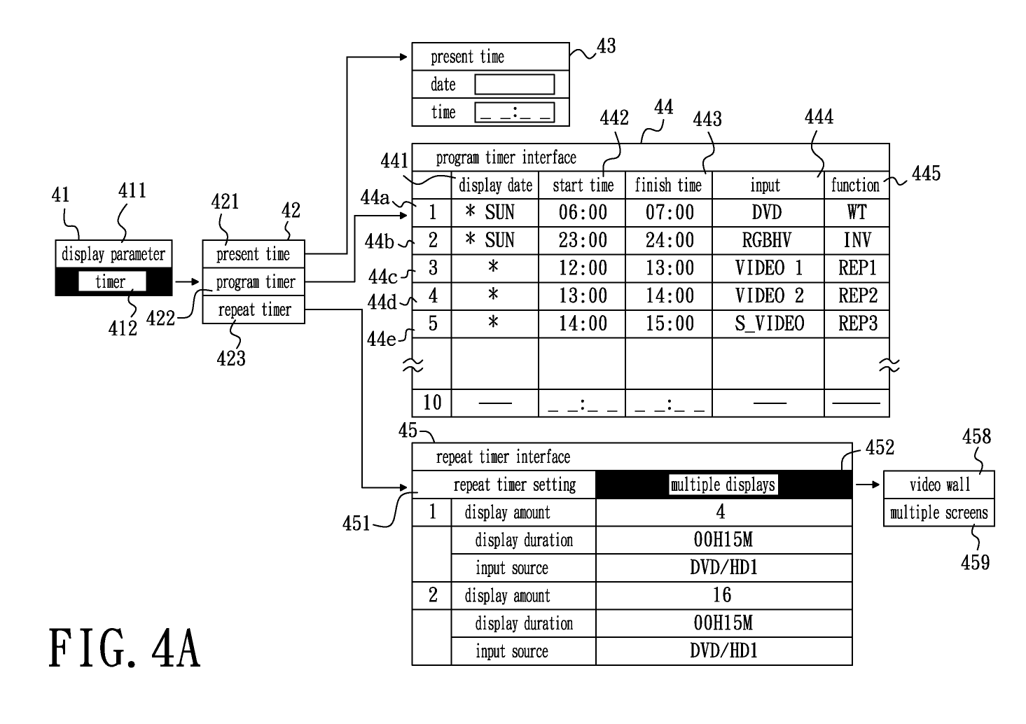

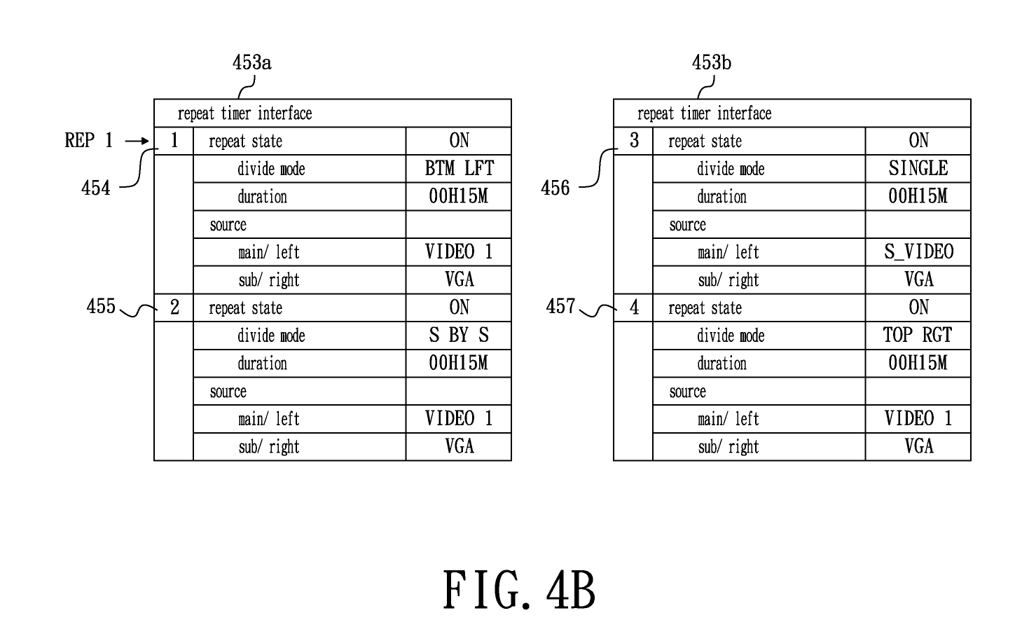

With referring to FIG. 4A, an OSD menu 41 according to an embodiment of the present invention includes a display parameter item 411 and a timer item 412 for popping up a timer menu 42. The timer menu 42 includes a present time item 421 for popping up a present time setting interface, a program timer item 422 for popping up a program timer interface 44, and a repeat timer item 423 for popping up a repeat timer interface 45.

More, the program timer interface 44 has the content scheduling records 44a to 44e, and each one of them includes a display date field 441, a start time field 442, a finish time field 443, an input field 444 and a function field 445. In the preferred embodiment, the display date field 441 may be filled with one of Monday (MON) to Sunday (SUN) and asterisked as periodical assignment. A one single asterisk without accompaniment indicating the display time is determined by the start time field 442 and the finish time field 443 just one time. It's noted that one single asterisk indicating the display time is determined by the start time field 442 and the finish time field 443 everyday, and the detailed content schedule is up to the content of the repeat timer interface 45. Moreover, input field 444 may be filled with the video source such as VIDEO 1, VIDEO 2, S-VIDEO, DVD, HD 1, VGA, RGBHV, DVI and MULTI. The function field 445 may be filled with the ways such as mentioned ORB, INV and WT for image retention removal, and the repeat timer index such as REP 1, REP 2 and REP 3. Thus the meaning of the content scheduling record 44a is that a white picture will be displayed for removing the image retention of the first display at am 6 to 7 every Sunday.

With referring to FIG. 4B, the repeat timer interface 453a and 453b are shown as two sequent input frames in corresponsive to a repeat timer index REP 1 of the content scheduling record 44c. There are four repeat content scheduling records 454 to 457 here, and each one includes a repeat state field, a divide mode field, a repeat duration field, a source allocation field and the parameter values. In the preferred embodiment, the repeat state field may be assigned the repeat and no repeat of the state in an ON and an OFF respectively; the repeat duration field may be assigned the duration of the state; the divide mode field may be filled with the setting for main-sub window schema such as display side by side (Side By Side), or display the sub window at a corner of the main window, for example, the sub window being on the top right (TOP RGT) of the main one or on the bottom left (BTM LFT); and the source allocation field further includes a first window source field and a second window source field for assigning the video source of the main-sub, single or multiple windows. Therefore, the content scheduling record 44c indicates the daily sequence of that the source VIDEO 1 and VGA are displayed in the main window and the sub window respectively for 15 minutes from am 12, then the source VIDEO 1 and VGA are displayed in the left window and the right window respectively for 15 minutes, then the source S-VIDEO is displayed in a single window for 15 minutes and finally the source VIDEO 1 and VGA are displayed in the main window and the sub window respectively till 1 pm. Therefore, the content scheduling of the display is modifiable.

Furthermore, with referring to the FIG. 4A again, the repeat timer item 423 pops up a repeat timer interface 45 with a repeat timer setting item 451 and a multiple displays item 452 for inputting the repeat content scheduling record and the multiple displays content scheduling record. Herein, the multiple displays item 452 includes a video wall monitor item 458 and a multiple screens item 459, and the multiple displays content scheduling record includes the display amount field, the display duration field and the input source field. Therefore, the first one of the multiple displays content scheduling records of the repeat timer interface 45 indicates that the source DVD or HD 1 will be displayed in four displays for 15 minutes, whereas the second one indicates that the source DVD or HD 1 will be displayed in 16 displays for 15 minutes. Therefore, it is achieved that the display content is displayed in a video wall monitor or multiple screens.

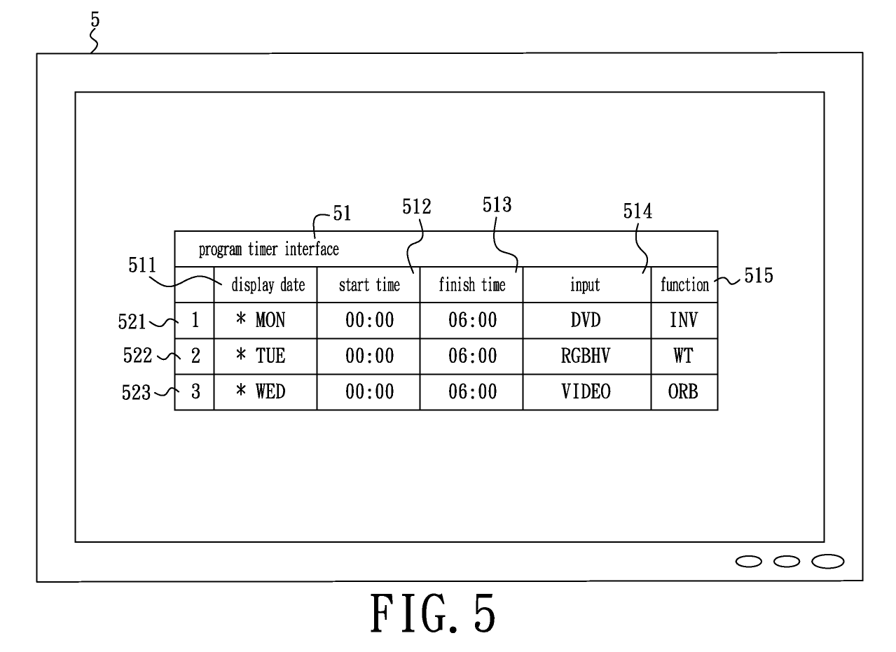

With referring to FIG. 5, a program timer interface 51 of a display 5 may be inputted one to many content scheduling records, and the content scheduling record includes a display date field 511, a start time field 512, a finish time field 513, an input field 514 and a function field 515. Herein, the inputted content of the function field 515 indicates the ways for the image retention removal. For instance, an ORB (orbiter) indicates to show a video content orbited over the display along a reference point of the display, an INV (inverse) indicates to show a video content with an inversed color value of original in the display, and a WT (white) indicates to show a white picture in the display. In detailed, according to the content scheduling record 521 to 523, the display 5 displays a DVD video content with an inversed color value of original from am 0 to 6 every Monday, a RGBHV white picture from am 0 to 6 every Tuesday, and a VIDEO content orbited over the display from am 0 to 6 every Wednesday, and the display content orbits over the display along a reference point of the display. Therefore, the image retention resulted from frequent displaying is eliminated and avoided.

Accordingly, the present invention reduces the costs of an expense in system environment establishing and maintaining, training fee and salary of system administrator, and also eliminates the disadvantages of indirect update and late response resulted from the prior art. In addition, the way for achieving image retention removal is assigned to a function field of the content scheduling record.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A content scheduling method for performing a content scheduling of a display with at least a content scheduling record, comprising:
creating a timer item with a program timer in an on screen display of the display;
selecting the program timer for popping up a program timer interface; and
inputting the content scheduling record in the program timer interface.

2. The method of claim 1, further comprising:
creating a present time item in the timer item and inputting an initial time in the present time item.

3. The method of claim 1, wherein the content scheduling record comprising a display date field, a start time field, a finish time field, an input field and a function field.

4. The method of claim 3, wherein an inputted content of the function field indicates one of an image retention removal and an execution of a repeat timer index.

5. The method of claim 4, further comprising:
popping up a repeat timer interface if the inputted content is the repeat timer index.

6. The method of claim 5, further comprising:
inputting at least a repeat content scheduling record to the repeat timer interface, wherein the repeat content scheduling record comprises a repeat state field, a divide mode field, a repeat duration field and a source allocation field.

7. The method of claim 6, wherein the source allocation field further comprises a first window source field and a second window source field.

8. The display of claim 5, further comprising:
selecting one of a video wall monitor item and a multiple screens item of a multiple displays item; and
inputting a multiple displays content scheduling record to the repeat timer interface.

9. The display of claim 8, wherein the multiple displays content scheduling record comprises a display amount field, a display duration field and an input source field.

10. A scheduling interface of display for performing a content scheduling of a display with at least a content scheduling record, comprising:
a program timer interface for inputting the content scheduling record;
a timer menu with a program timer item for popping up the program timer interface; and
an on screen display menu with a timer item for popping up the timer menu.

11. The scheduling interface of claim 10, wherein the timer item further comprising:
a present time item for inputting an initial time.

12. The scheduling interface of claim 10, further comprising:
a repeat timer interface, popped up if an inputted content of a function field of the content scheduling record is a repeat timer index, for inputting at least one of a repeat content scheduling record and a multiple displays content scheduling record.

13. The scheduling interface of claim 12, wherein the repeat timer interface further comprises a multiple displays item with a video wall monitor item and a multiple screens item for inputting the multiple displays content scheduling record.

14. The scheduling interface of claim 10, wherein the timer menu further comprises a repeat timer item.

15. A display with image retention removal, comprising:
a program timer interface for inputting an content scheduling record, wherein an inputted content of a function field of the content scheduling record indicates the removal of an image retention.

16. The display of claim 15, wherein the inputted content indicates to show a video content or a specific video content orbited over the display along a reference point of the display.

17. The display of claim 15, wherein the inputted content indicates to show a video content or a specific video content with an inversed color value of original in the display.

18. The display of claim 15, wherein the inputted content indicates to show a white picture in the display.
